(19) United States
(12) Patent Application Publication
(10) Pub. No.: US 2010/0177819 A1
(43) Pub. Date: Jul. 15, 2010

(54) METHOD AND AN APPARATUS FOR PROCESSING A VIDEO SIGNAL

(75) Inventors: Byeong Moon Jeon, Seoul (KR); Seung Wook Park, Seoul (KR); Joon Young Park, Seoul (KR); Hyun Wook Park, Daejeon (KR); Dong San Jun, Daejeon (KR); Yinji Piao, Daejeon (KR); Jee Hong Lee, Daejeon (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/602,205

(22) PCT Filed: May 29, 2008
(86) PCT No.: PCT/KR2008/003022

§ 371 Date: Nov. 30, 2009

Related U.S. Application Data
(60) Provisional application No. 60/924,694, filed on May 29, 2007.
(60) Provisional application No. 60/929,039, filed on Jun. 8, 2007.
(60) Provisional application No. 60/989,842, filed on Nov. 22, 2007.

(51) Int. Cl. H04N 7/30

(52) U.S. Cl. 375/240.2; 375/E07.226

(57) ABSTRACT

An apparatus for processing a video signal and method thereof are disclosed. The present invention includes receiving the video signal, extracting discrete cosine transform information from the video signal, and performing inverse discrete cosine transform using the discrete cosine transform information, wherein the discrete cosine transform information indicates a rearrangement mode of blocks in the discrete cosine transform. Accordingly, a video signal processing method of the present invention, improves efficiency of discrete cosine transform in a manner of rearranging blocks of video signal by considering a prediction mode prior to performing discrete cosine transform. The present invention enhances coding efficiency by using a row or column shifted matrix and shift information including information relevant to the row or column shifted matrix and by directly performing RRU (reduced resolution update) scheme on a discrete cosine transform/inverse discrete cosine transform domain.

### TECHNICAL FIELD

The present invention relates to a method and apparatus for processing a video signal, and more particularly, to a video signal processing method and apparatus for encoding or decoding video signals.

### BACKGROUND ART

Generally, compression coding means a series of signal processing techniques for transferring digitalized information via a communication circuit or storing digitalized information in a format suitable for a storage medium. Targets of compression coding include audio, video, character, etc. In particular, a technique of performing compression coding on video is called video compression. Video sequence is generally characterized in having spatial redundancy and temporal redundancy.

### DISCLOSURE OF THE INVENTION

### Technical Problem

However, if the spatial redundancy and the temporal redundancy are not sufficiently eliminated, a compression rate in coding a video signal is lowered. If the spatial redundancy and the temporal redundancy are excessively eliminated, it is unable to generate information required for decoding a video signal to degrade a reconstruction ratio.

### Technical Solution

Accordingly, the present invention is directed to an apparatus for processing a video signal and method thereof that substantially obviate one or more of the problems due to limitations and disadvantages of the related art.

An object of the present invention is to provide an apparatus for processing a video signal and method thereof, by which compression efficiency can be raised by performing discrete cosine transform in a manner of rearranging blocks.

Another object of the present invention is to provide an apparatus for processing a video signal and method thereof, by which coding efficiency can be enhanced in a manner of shifting a row or column of a transform coefficient matrix in discrete cosine transform.

### ADVANTAGEOUS EFFECTS

Accordingly, the present invention provides the following effects and/or advantages.

First of all, a video signal processing method according to the present invention can enhance coding efficiency by concentrating low frequency components on a left top in a manner of rearranging blocks of video signal prior to performing discrete cosine transform.

Secondly, a video signal processing method according to the present invention can enhance compression efficiency by adopting a rearrangement method in a manner of considering a prediction mode in rearranging blocks prior to performing discrete cosine transform.

Thirdly, a video signal processing method according to the present invention can enhance coding efficiency using a row or column shifted matrix and shift information including information relevant to the row or column shifted matrix in a discrete cosine transform coefficient matrix.

Fourthly, a video signal processing method according to the present invention can raise coding efficiency and reduce complexity of operation by performing downsampling in a manner of directly performing RRU (reduced resolution update) scheme on a discrete cosine transform domain.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram of an apparatus for encoding a video signal according to one embodiment of the present invention;

FIG. 2 is a schematic block diagram of an apparatus for decoding a video signal according to one embodiment of the present invention;

FIG. 3A is a diagram for a reduced resolution update scheme within a block according to a first embodiment of the present invention;

FIG. 3B is a diagram for a reduced resolution update scheme on a block boundary according to a first embodiment of the present invention;

FIG. 4 is a schematic block diagram of a video signal encoding apparatus for a first embodiment of the present invention;

FIG. 5 is a schematic block diagram of a video signal decoding apparatus for a first embodiment of the present invention;

FIG. 6 is a graph for a base image used for a second embodiment of the present invention;

FIG. 7 is a graph for a reduced resolution update (RRU) scheme using discrete cosine transform according to a second embodiment of the present invention;

FIG. 8 is a flowchart for a reduced resolution update (RRU) scheme using discrete cosine transform according to a second embodiment of the present invention;

FIGS. 9A to 9C are diagrams for a method of rearranging residual signals according to a third embodiment of the present invention;

FIGS. 10A to 10D are diagrams for coefficients and discrete cosine transform coefficients of residual signals according to a third embodiment of the present invention;

FIGS. 11A to 11I are diagrams for a method of rearranging residual signals according to a fourth embodiment of the present invention;

FIG. 12A and FIG. 12B are diagrams for a discrete cosine transform coefficient matrix of residual signal (A, B) and the number of bits required for coding; and

FIG. 13 is a diagram for a discrete cosine transform coefficient shift scheme according to a fifth embodiment of the present invention.

### BEST MODE

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of processing a video signal according to the present invention includes receiving the video signal, extracting discrete cosine transform information from the video signal, and performing inverse discrete cosine transform using the discrete cosine transform information, wherein the discrete cosine transform information indicates a rearrangement mode of blocks in the discrete cosine transform.

According to the present invention, the discrete cosine transform information includes a first rearrangement mode not considering a prediction mode of the blocks and a second rearrangement mode considering the prediction mode of the blocks.

According to the present invention, the second rearrangement mode includes nine kinds of modes according to an intra-prediction mode of the blocks.

According to the present invention, each of the first and second rearrangement modes concentrates low frequency components of the blocks on a left top.

According to the present invention, the blocks include 8*8 or 4*4 blocks.

To further achieve these and other advantages and in accordance with the purpose of the present invention, a method of processing a video signal according to the present invention includes receiving the video signal, extracting discrete cosine transform information and reduced resolution update information from the video signal, and performing inverse discrete cosine transform using the discrete cosine transform information and the reduced resolution update information, wherein the discrete cosine transform information indicates a rearrangement mode of blocks in the discrete cosine transform.

According to the present invention, the reduced resolution update information indicates whether to perform the inverse discrete cosine transform by upsampling the blocks.

According to the present invention, the upsampling is performed in a discrete cosine transform domain.

According to the present invention, the upsampling substitutes 0 for a high frequency component eliminated in encoding by being downsampled.

According to the present invention, the downsampling is performed by eliminating samples located at points over a predetermined point in a discrete cosine transform domain in encoding the video signal.

To further achieve these and other advantages and in accordance with the purpose of the present invention, a method of processing a video signal according to the present invention includes receiving the video signal, extracting discrete cosine transform information and discrete cosine transform coefficient shift information from the video signal, and performing inverse discrete cosine transform using the discrete cosine transform information and the discrete cosine transform coefficient shift information, wherein the discrete cosine transform information indicates a rearrangement mode of blocks in the discrete cosine transform.

According to the present invention, the discrete cosine transform coefficient information indicates a presence or non-presence of a shift, shift direction and shift extent of a transform coefficient matrix in performing discrete cosine transform of the blocks.

To further achieve these and other advantages and in accordance with the purpose of the present invention, a method of processing a video signal according to the present invention includes transforming a block of the video signal including N samples in a discrete cosine transform domain and performing downsampling by selecting the sample existing on a point equal to smaller than N/2 in the discrete cosine transform domain.

According to the present invention, the video signal is received via a video signal.

According to the present invention the video signal is received via a digital medium.

To further achieve these and other advantages and in accordance with the purpose of the present invention,

A computer-readable-medium according to the present invention includes a program recorded therein to execute a method of processing a video signal according to the present invention, the method including receiving the video signal, extracting discrete cosine transform information from the video signal, and performing inverse discrete cosine transform using the discrete cosine transform information, wherein the discrete cosine transform information indicates a rearrangement mode of blocks in the discrete cosine transform.

It is to be understood that both the foregoing general description and the following detailed description are exemplary and explanatory and are intended to provide further explanation of the invention as claimed.

### Mode for Invention

Reference will now be made in detail to the preferred embodiments of the present invention, examples of which are illustrated in the accompanying drawings. General terminologies used currently and globally are selected as terminologies used in the present invention. And, there are terminologies arbitrarily selected by the applicant for special cases, for which detailed meanings are explained in detail in the description of the preferred embodiments of the present invention. Hence, the present invention should be understood not with the names of the terminologies but with the meanings of the terminologies.

Specifically, coding in the present invention should be understood as the concept including both encoding and decoding.

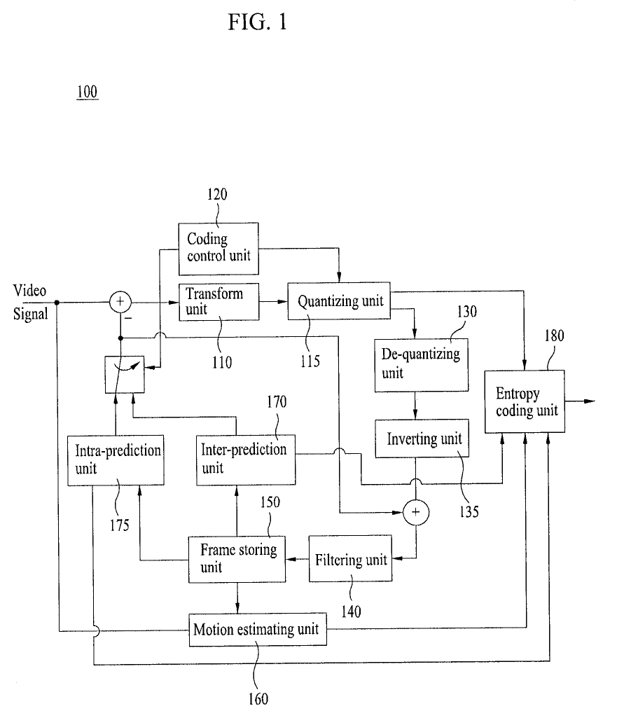

FIG. 1 is a schematic block diagram of an apparatus for encoding a video signal according to one embodiment of the present invention. Referring to FIG. 1, a video signal encoding apparatus 100 according to one embodiment of the present invention includes a transform unit 110, a quantizing unit 115, a coding control unit 120, a de-quantizing unit 130, an inverting unit 135, a filtering unit 140, a frame storing unit 150, a motion estimating unit 160, an inter-prediction unit 170, an intra-prediction unit 175, and an entropy coding unit 180.

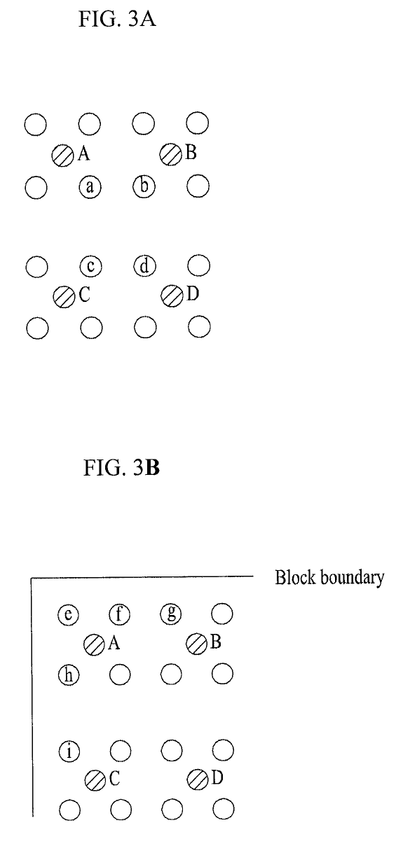

The transform unit 110 obtains a transform coefficient value by transforming a pixel value. For this, discrete cosine transform (DCT) or wavelet transform is usable. In particular, the discrete cosine transform raises compression efficiency by dividing an inputted video signal into 8*8 blocks and concentrating a signal on the video signal having a small number. And, embodiment of discrete cosine transform proposed by the present invention will be described later with reference to FIG. 3. The quantizing unit 115 quantizes the transform coefficient value outputted by the transform unit 110. The coding control unit 120 controls whether to perform intra-picture coding or inter-picture coding on a specific block or frame. The de-quantizing unit 130 and the inverting unit 135 de-quantize the transform coefficient value and then reconstruct an original pixel value using the de-quantized transform coefficient value.

The filtering unit 140 is applied to each coded macroblock to reduce block distortion. In this case, a filter smoothens edges of a block to enhance an image quality of a decoded picture. And, a selection of this filtering process depends on a boundary strength and gradient of an image sample around a boundary. The filtered picture is outputted or stored in the frame storing unit 145 to be used as a reference picture.

The motion estimating unit 160 searches reference pictures for determining of a reference block most similar to a current block using the reference pictures stored in the frame storing unit 145. And, the motion estimating unit 160 forwards position information of the searched reference block and the like to the entropy coding unit 180 so that the forwarded position information and the like can be contained in a bitstream.

The inter-prediction unit 170 performs prediction of a current picture using the reference picture and forwards inter-picture coding information to the entropy coding unit 180. And, the intra-prediction unit 175 performs intra-picture prediction from a decoded sample within the current picture and forwards intra-picture coding information to the entropy coding unit 180.

The entropy coding unit 180 generates a video signal bitstream by entropy-coding the quantized transform coefficient, the inter-picture coding information, the intra-picture coding information and the reference block information inputted from the motion estimating unit 160. In this case, the entropy coding unit 180 can use variable length coding (VLC) scheme and arithmetic coding scheme. The variable length coding scheme transforms inputted symbols into continuous codeword. In this case, the length of the codeword may be variable. For instance, frequently generated symbols are represented as short codeword and non-frequently generated symbols are represented as long codeword. As the variable length coding scheme, context-based adaptive variable length coding (CAVLC) is usable. The arithmetic coding transforms continuous data symbols into a single prime number. And, the arithmetic coding can obtain optimal prime bit required for representing each symbol. As the arithmetic coding, context-based adaptive binary arithmetic (CABAC) is usable.

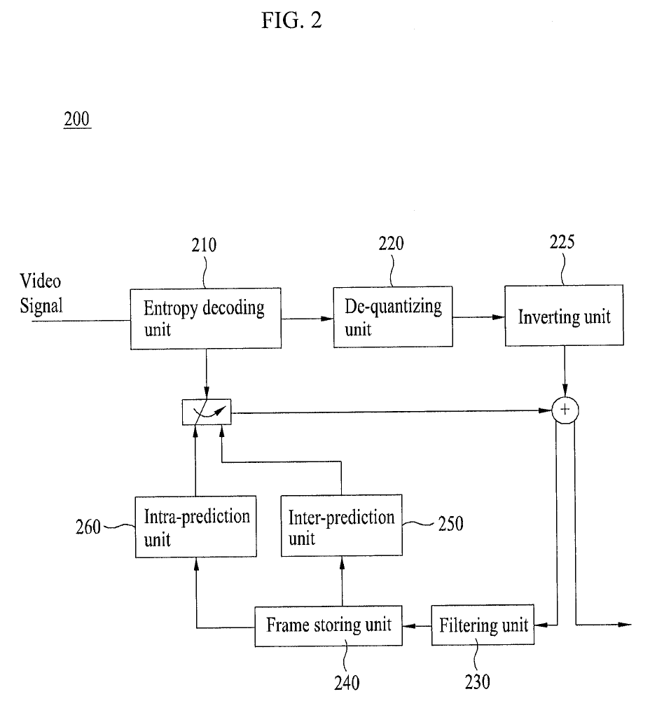

FIG. 2 is a schematic block diagram of an apparatus for decoding a video signal according to one embodiment of the present invention. Referring to FIG. 2, a video signal decoding apparatus of the present invention mainly includes an entropy decoding unit 210, a de-quantizing unit 220, an inverting unit 225, a filtering unit 230, a frame storing unit 240, an inter-prediction unit 250, and an intra-prediction unit 260.

The entropy decoding unit 210 extracts a transform coefficient, motion vector and the like of each macroblock by entropy-decoding a video signal bitstream. The de-quantizing unit 220 de-quantizes the entropy-decoded transform coefficient and the inverting unit 225 reconstructs an original pixel value using the de-quantized transform coefficient. Meanwhile, the filtering unit 230 is applied to each coded macroblock to reduce block distortion. A filter enhances an image quality of a decoded picture by smoothening edges of a block. The filtered picture is outputted or stored in the frame storing unit 240 to be used as a reference picture.

The inter-prediction unit 260 predicts a current picture using the reference picture stored in the frame storing unit 240. In this case, as mentioned in the foregoing description, the reference picture is used. Meanwhile, the intra-prediction unit 265 performs intra-picture prediction from a decoded sample within a current picture. A prediction value outputted from the intra-prediction unit 265 or the inter-prediction unit 260 and a pixel value outputted from the inverting unit 225 are added together to generate a reconstructed video frame.

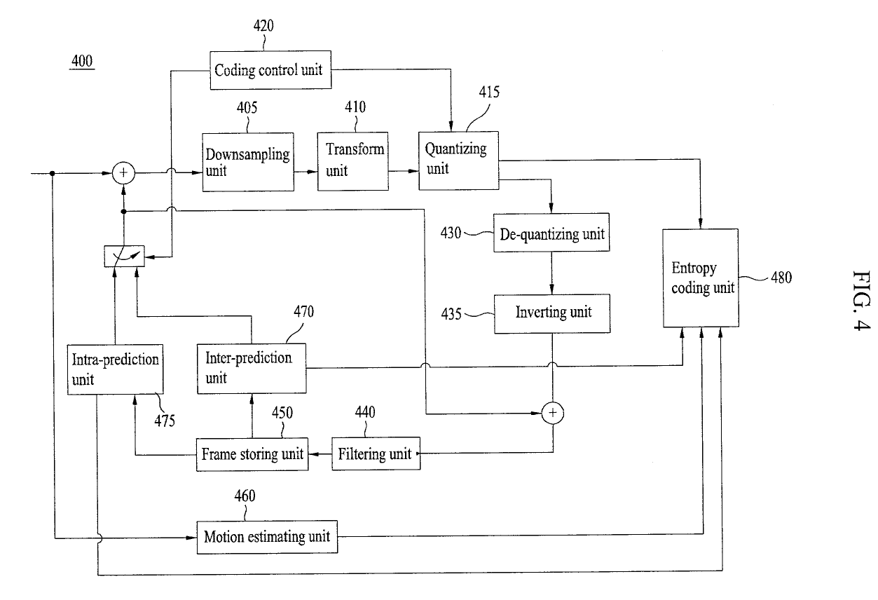

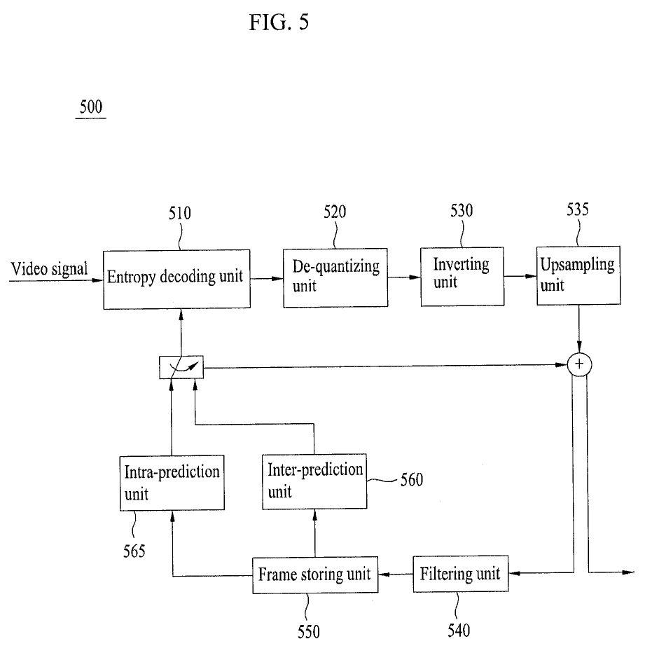

In the following description, reduced resolution update (RRU) scheme according to a first embodiment of the present invention is explained with reference to FIG. 3A and FIG. 3B, and video signal encoding and decoding apparatuses adopting the reduced resolution update (RRU) scheme are explained with reference to FIG. 4 and FIG. 5.

First of all, the reduced resolution update (RRU) scheme means the encoding scheme for transforming and quantizing the downsampled values resulting from downsampling residual values obtained by motion compensation in a spatial domain. The reduced resolution update (RRU) scheme adopts the scheme for encoding an image at reduced resolution by performing prediction that uses a high resolution reference allowing reconstruction of a final image at full resolution. Therefore, the reduced resolution update (RRU) scheme provides a change for increasing coding speed simultaneously with transforming and quantizing a video signal by maintaining a sufficient subjective quality. In particular, the reduced resolution update (RRU) scheme is useful while heavy motion exists within a picture sequence. This is because an encoder maintains a high frame speed while maintaining high resolution and quality in a non-moving area.

If the reduced resolution update (RRU) scheme is adopted, compared to an image coded at full resolution (coded at resolution before downsampling), an image of a video signal has ¼ of macroblock number. And, motion vector data is associated with 32*32 or 16*16 block size of image at full resolution instead of 16*16 or 8*8. On the other hand, discrete cosine transform (DCT) and texture data are associated with 8*8 blocks of image at reduced resolution. And, an upsampling process is mandatory to finally generate full image representation.

The reduced resolution update (RRU) scheme may result in reduction in objective quality. Yet, the reduced resolution update (RRU) scheme is more compensated by the reduction of bits used for encoding due to motion data and reduced residual data.

FIG. 3A and FIG. 3B are diagrams for a method of upsampling encoded video signals downsampled by reduced resolution update (RRU) scheme according to a first embodiment of the present invention.

Referring to FIG. 3A, pixels A, B, C and D are obtained from being downsampled by reduced resolution update (RRU) scheme. If the pixels A, B, C and D exist within a block, value of neighbor pixels obtained from being upsampled by interpolation can be expressed as Formula 1.

a=(9A+3B+3C+D+8)/16

b=(3A+9B+C+3D+8)/16

c=(3A+B+9C+3D+8)/16

d=(A+3B+3C+9D+8)/16 [Formula 1]

FIG. 3B shows a case that pixels located on a block boundary are encoded by being downsampled in a spatial domain. And, values of neighbor pixels obtained by performing interpolation on the pixels A, B, C and D can be represented as Formula 2.

e=A

f=(3A+B+2)/4

g=(A+3B+2)/4

h=(3A+C+2)/4

I=(A+3C+2)/4 [Formula 2]

FIG. 4 is a schematic block diagram of a video signal encoding apparatus 400 adopting the reduced resolution update scheme. FIG. 5 is a schematic block diagram of a video signal decoding apparatus 500 adopting the reduced resolution update scheme. In FIG. 4 and FIG. 5, a transform unit 410, a quantizing unit 415, a coding control unit 420, de-quantizing units 430 and 520, inverting units 435 and 530, filtering units 440 and 540, frame storing units 450 and 550, a motion estimating unit 460, inter-prediction units 470 and 560, intra-prediction units 475 and 565 and entropy coding units 480 and 510 are equivalent to those of the video signal processing apparatuses shown in FIG. 1 and FIG. 2 with the same configurations and purposes. Therefore, their details will be omitted in the following description.

Referring to FIG. 4, a video signal encoding apparatus 400 according to the present invention includes a downsampling unit 305 to downsample at least a portion of a residual of a video signal prior to transform and quantization of the residual. The downsampling unit 305 enables an image to be encoded at a reduced resolution while performing prediction on an inputted video signal using a high resolution reference that allows a final image to be reconstructed at full resolution. Therefore, it is able to increase coding image speed by maintaining a subjective quality sufficiently.

Referring to FIG. 5, a video signal decoding apparatus 500 according to the present invention includes an upsampling unit 535 to upsample a residual value obtained through an inverting unit 530. Thus, the reduced number of residuals obtained from downsampling are de-quantized and inverted by a de-quantizing unit 520 and the inverting unit 530, respectively. The inverted residual value is then upsampled to reduce an operation quantity smaller than that of the case of de-quantizing and inverting the entire residuals.

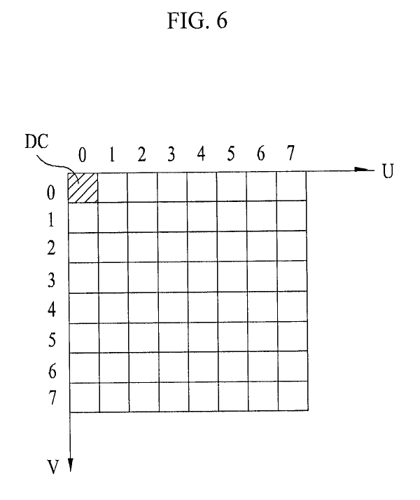

In the former reduced resolution update (RRU) scheme according to the first embodiment of the present invention, downsampling is performed in a spatial domain prior to discrete cosine transform. Yet, in reduced resolution update (RRU) scheme according to the second embodiment of the present invention, downsampling is performed in a frequency domain obtained as a result of discrete cosine transform to reduce an operation quantity. This is explained with reference to FIGS. 6 to 8 as follows.

First of all, discrete cosine transform (DCT) is one of orthogonal exchanges and is the same kind of discrete frequency transform (DFT). In the discrete cosine transform (DCT), video data is divided into 8*8 blocks and an operation of discrete cosine transform (DCT) is performed on a pixel within the block. Transform and inverting formulas of the discrete cosine transform (DCT) are represented as Formula 3 and Formula 4, respectively.

$$\begin{matrix}F ( u , v ) = \frac{1}{4} C ( u ) C ( v ) {\sum }_{i = 0}^{7} {\sum }_{j = 0}^{7} f ( i , j ) cos \frac{( 2 i + 1 ) u π}{16} cos \frac{( 2 j + 1 ) v π}{16} & [ Formula 3 ] \\ f ( i , j ) = \frac{1}{4} {\sum }_{u = 0}^{7} {\sum }_{v = 0}^{7} C ( u ) C ( v ) F ( u , v ) cos \frac{( 2 i + 1 ) u π}{16} cos \frac{( 2 j + 1 ) v π}{16} & [ Formula 4 ]\end{matrix}$$

In Formula 3 and Formula 4, (i,j) indicates a position of pixel and (u,v) indicates a 2-dimensional position of frequency. Moreover, f(i,j) indicates an input image, F(u,v) indicates a transform image, and a coefficient C(u) has the following value.

$$\begin{matrix}C ( u ) = \frac{1}{\sqrt{2}} , & u = 0 \\ 1 , & u \neq 0 \\ C ( v ) = \frac{1}{\sqrt{2}} , & v = 0 \\ 1 , & v \neq 0\end{matrix}$$

Discrete cosine transform (DCT) means the processing for resolving (transforming) a signal in a spatial domain into 2-dimensional frequency components. And, FIG. 6 shows a base image that represents frequency components. Left top has low frequency components in horizontal and vertical directions. And, the frequency components get higher toward a right bottom. Hence, the patterns are complicated. In this case, a frequency component existing on a most left top among total 64 2-dimensional frequency components is a DC (direct current) component of which frequency is 0. And, the rest of the components are AC (alternate current) components and include total 63 components ranging from a low frequency component to a high frequency component. Signals (or patterns) in nature tend to exist on left top and become rare toward right bottom. Hence, it is able to obtain compression effect in case of performing discrete cosine transform. This is because a human has lower error sensitivity for a high frequency component. Performing discrete cosine transform is to find each size of base components (64 basic pattern components) included in a block of an original video signal. And, the corresponding size is a discrete cosine transform coefficient.

Moreover, discrete cosine transform (DCT) is the transform used to represent an original video signal as a frequency component. And, in inverse transform, the original video signal is fully reconstructed from the frequency component. In other words, the discrete cosine transform (DCT) just changes a video representing method. And, all information contained in an original image is preserved as well as overlapped information.

In case of performing discrete cosine transform (DCT) on an original image, unlike amplitude distribution of the original image, discrete cosine transform coefficient values exist in a manner of gathering into values around 0. Using this phenomenon, it is able to obtain high compression effect.

In case of adopting the reduced resolution update (RRU) scheme according to the first embodiment of the present invention, prior to performing the discrete cosine transform (DCT), downsampling is performed on an original video signal in the mode of spatial domain. The downsampling is performed in a manner of deleting signals existing in odd order among present original video signals. Thereafter, the discrete cosine transform (DCT) is performed to transform the remaining video signals into frequency domain.

On the contrary, a video signal processing method and apparatus according to the second embodiment of the present invention perform the reduced resolution update (RRU) scheme not in spatial domain but in discrete cosine transform domain.

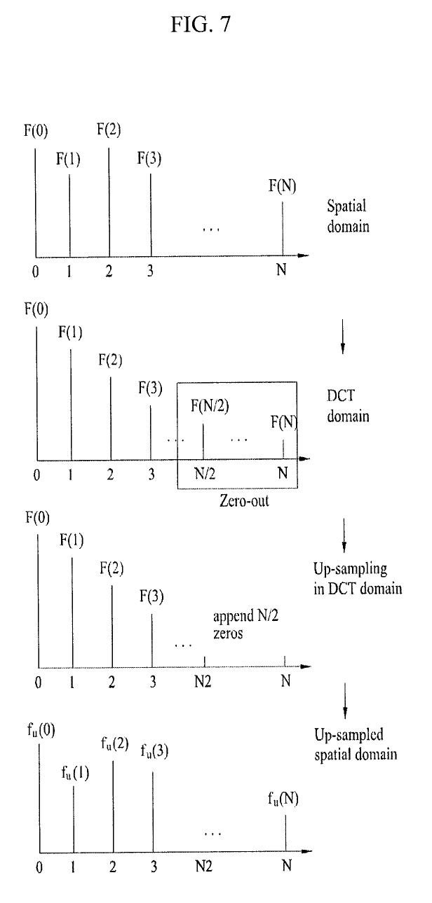

FIG. 7 is a graph for a method of performing reduced resolution update (RRU) in a discrete cosine transform (DCT) domain. First of all, discrete cosine transform (DCT) is performed on all signals existing in a spatial domain by Formula 5.

X_{8×8}(I,J)=H_{8×8}·x_{8×8}(i,j)·H_{8×8}^{t} [Formula 5]

If such a transform is performed, a large DCT coefficient tends to occur on a low frequency band and a DCT coefficient becomes smaller toward a high frequency band. In the discrete cosine transform (DCT) of FIG. 7, as shown in Formula 6, downsampling for resolution reduction is performed by taking a value existing on a low frequency band in the transformed discrete cosine domain only. High frequency band, which is not used by the above process, may be the band existing over N/2 points among total N signals.

X_{4×4}(I,J)={0<I,J<3|X_{8×8}(I,J)} [Formula 6]

Subsequently, quantization is performed on signals in the transformed discrete cosine transform domain by Formula 7.

X_{4×4}(I,J)={0<I,J<3|X_{8×8}(I,J)} [Formula 7]

In encoding, if downsampling is performed in a discrete cosine transform domain by adopting the reduced resolution update scheme, it is able to transmit reduced resolution update (RRU) information, which indicates the downsampling by the adopted reduced resolution update (RRU) scheme, to a decoder. And, the reduced resolution update (RRU) information can contain resolution information of an original image prior to the downsampling as well as the information indicating whether the downsampling is performed in the discrete cosine transform domain.

Moreover, upsampling in decoding is performed in the discrete cosine domain by Formulas 8 to 10. In case that the reduced resolution update information extracted from a video signal inputted to the decoder indicates that the downsampling has been performed, a value of 0 is given to a high frequency band that was not selected in encoding after inverse discrete cosine transform. As mentioned in the foregoing description, since a high frequency band in a discrete cosine transform domain has a small value, an image quality of a video reconstructed in upsampling has a less difference from that of an original image.

$$\begin{matrix}{X}_{4 \times 4}^{′} ( I , J ) = {IQ}_{8} \{ {\hat{X}}_{4 \times 4} ( I , J ) \} & [ Formula 8 ] \\ {X}_{8 \times 8}^{′} ( I , J ) = \begin{matrix}{X}_{4 \times 4}^{′} , & when , 0 〈 I , J 〈 3 \\ 0 , & otherwise\end{matrix} & [ Formula 9 ] \\ {x}_{8 \times 8}^{′} ( i , j ) = {H}_{8 \times 8}^{t} \cdot {X}_{8 \times 8}^{′} ( I , J ) \cdot {H}_{8 \times 8} & [ Formula 10 ]\end{matrix}$$

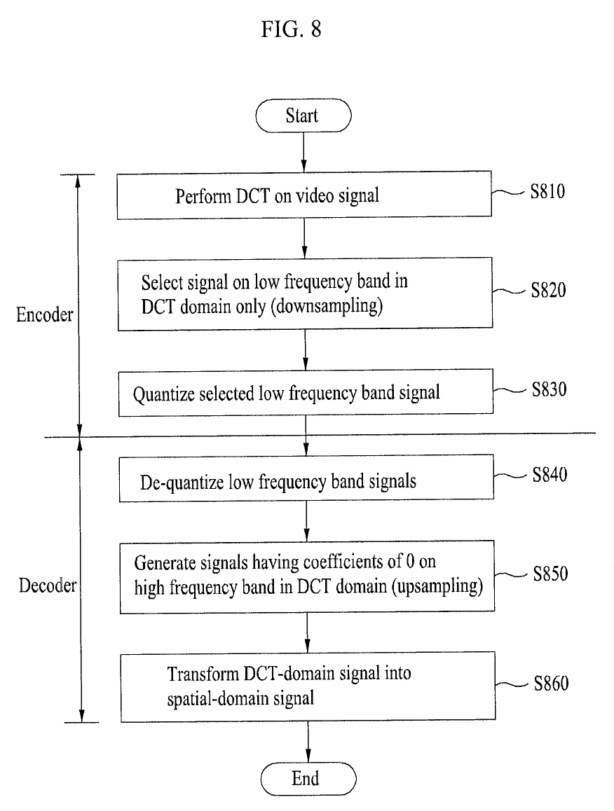

FIG. 8 is a flowchart for a reduced resolution update (RRU) scheme using discrete cosine transform according to a second embodiment of the present invention. Referring to FIG. 8, steps S810 to S830 are the steps performed by an encoder. And, the steps S810 to S830 can be performed by the video signal encoding apparatus according to one embodiment of the present invention described with reference to FIG. 1. Steps S840 to S860 are the steps performed by a decoder. And, the steps S840 to S860 can be performed by the video signal decoding apparatus according to one embodiment of the present invention described with reference to FIG. 2.

First of all, the encoder performs discrete cosine transform on entire video signals existing in a spatial domain [S810]. A discrete cosine transform scheme according to a first embodiment of the present invention includes a resolution reducing step of selecting a portion of the video signals in a spatial domain prior to discrete cosine transform. On the contrary, a discrete cosine transform scheme according to a second embodiment of the present invention omits the resolution reducing step in the spatial domain but performs discrete cosine transform on entire signals in a spatial domain.

By selecting the signals existing on a low frequency band from the video signals in the discrete cosine transform domain transformed in the step S810 and then removing samples existing on a high frequency band in the discrete cosine transform domain instead of the spatial domain, downsampling is performed [S820]. Moreover, by performing quantization on the discrete cosine transform signals downsampled in the step S820, it is able to obtain encoded video signals [S830]. In this case, it is able to encode both reduced resolution update information indicating whether a reduced resolution update scheme is performed in the discrete cosine transform domain and including resolution information of an original image prior to the downsampling together.

If so, a decoder receives a video signal bitstream containing the reduced resolution update information and then performs de-quantization [S840]. The de-quantized signal in the discrete cosine transform domain exists on the low frequency band only. In this case, upsampling for reconstructing resolution of an original image is performed by substituting a value of 0 for the high frequency band [S850]. Subsequently, the upsampled signal in the discrete cosine transform domain is transformed into a signal in the spatial domain [S860].

Thus, in case of using the reduced resolution update scheme for selecting the signals on the low frequency band in performing the encoding in the discrete cosine transform domain or giving 0 to the value of the high frequency band in performing the decoding, it is able to omit the steps for downsampling and upsampling in the spatial domain. Moreover, since the downsampling and upsampling for the coding of the reduced resolution update scheme can be performed without additional calculations, it is able to reduce an operation quantity.

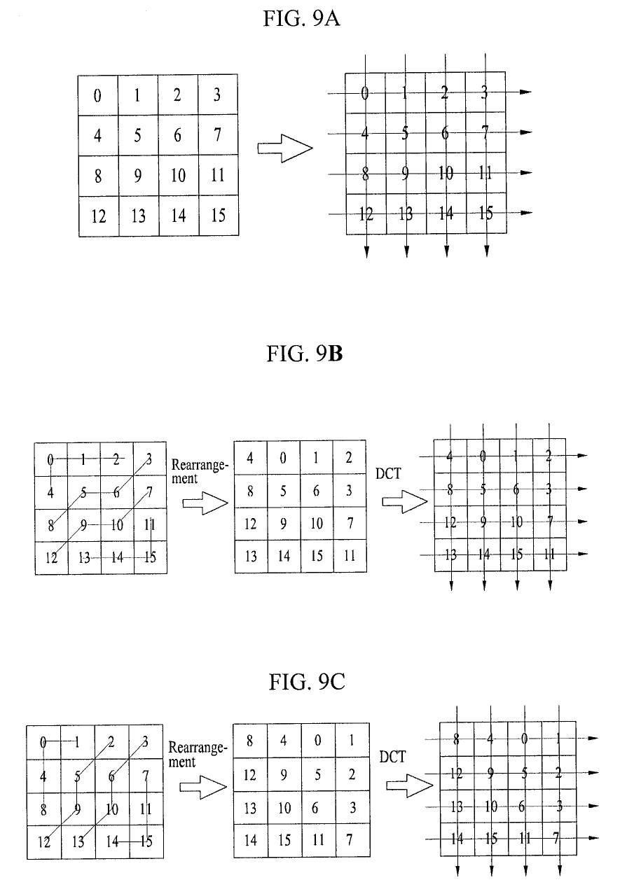

In the following description, a video signal processing method, which reduces a bit rate by rearranging video signals prior to discrete cosine transform and also reduces error from an original image, according to another embodiment of the present invention is explained with reference to FIGS. 9A to 11I.

First of all, a current discrete cosine transform scheme transforms an original image into 2-dimensional frequency components, finds sizes of base components contained in block of the original image in transform, quantizes the found sizes, and then performs zigzag scan. The discrete-cosine-transformed video signal may be an original video signal or a residual signal. In this case, the neighbor original video signal or residual signals are irregular but may have similarity to each other.////Therefore, in discrete cosine transform, by leading the discrete cosine transform coefficient to gather around the DC component, rather than the case of performing general discrete cosine transform, in a manner of further including the step of rearranging the original signal or residual signals similar to each other by considering similarity thereof, it is able to improve a compression ratio. Explained in the following is the case that blocks to be rearranged are residual signals.

In the discrete cosine transform, a third embodiment of the present invention proposes a first rearrangement mode that is a method of rearranging residual signals without considering a prediction mode and a fourth embodiment of the present invention proposes a second rearrangement mode that is a method of rearranging residual signals by considering a prediction mode.

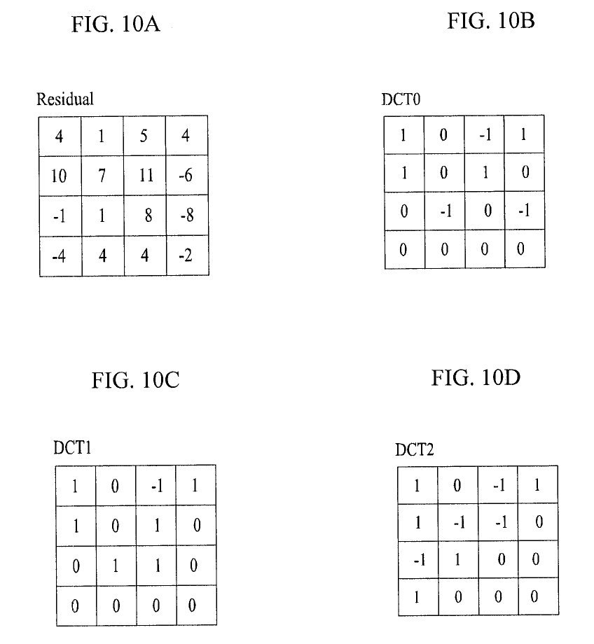

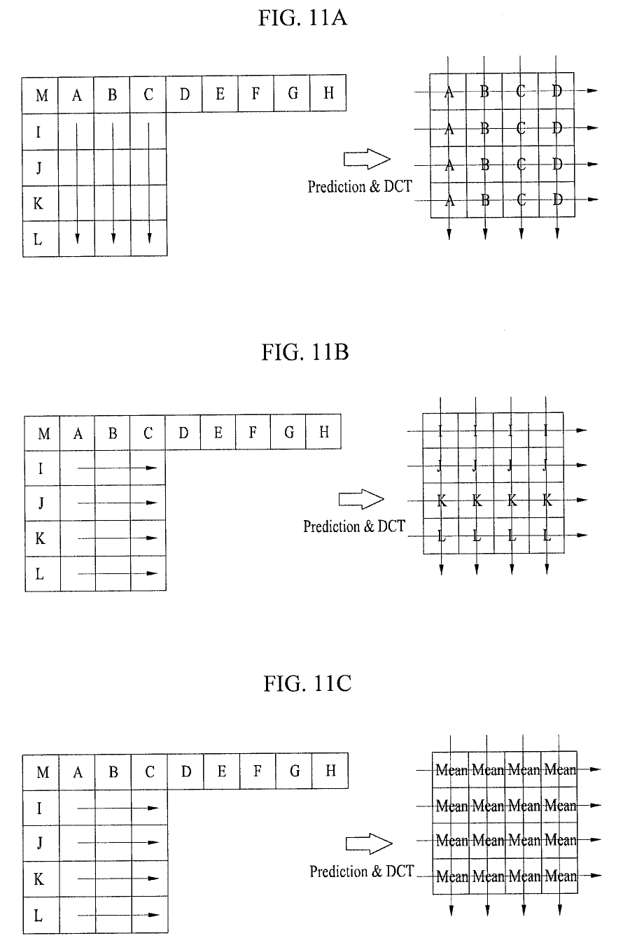

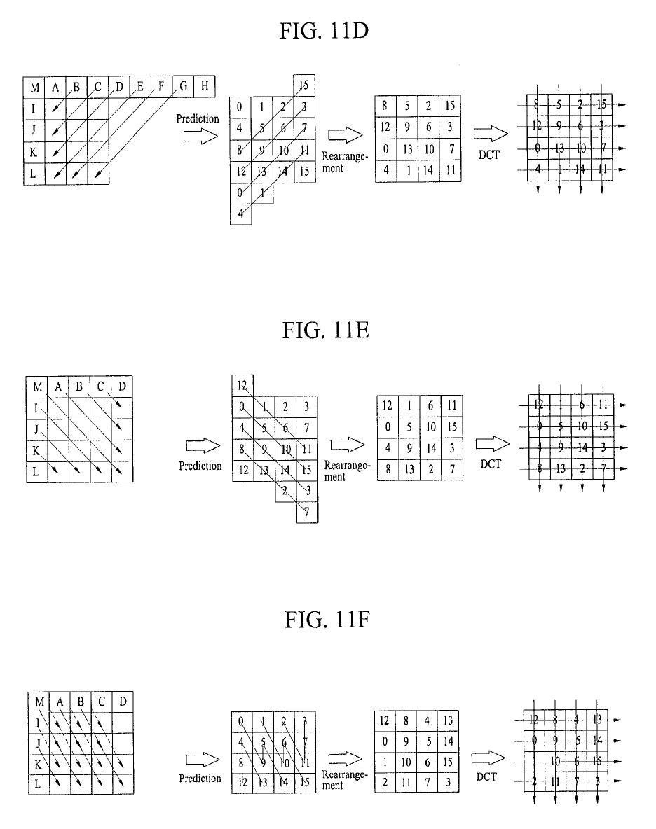

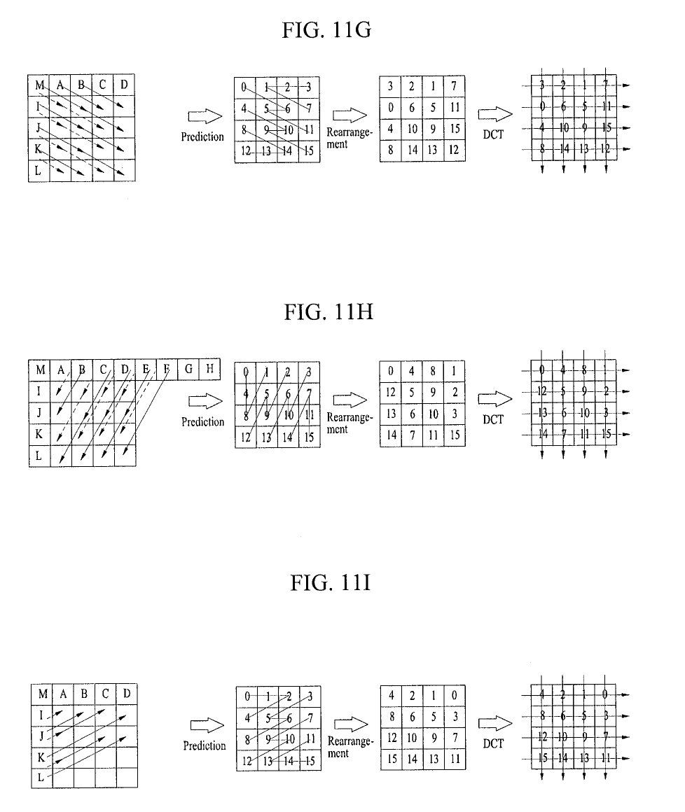

FIGS. 9A to 10D are diagrams for a discrete cosine transform method using a first rearrangement mode according to a third embodiment of the present invention, and FIGS. 11A to 11I are diagrams for a discrete cosine transform method using a second rearrangement mode according to a fourth embodiment of the present invention.

FIGS. 9A to 9C show a discrete cosine transform method by rearranging 4*4 residual signals using a first rearrangement mode, in which the first rearrangement mode includes three kinds of modes DCT0, DCT1 and DCT2 according to rearrangement directions. First of all, in case of using the first rearrangement mode, four blocks neighbor to each block after rearrangement should come from eight blocks neighbor to each block before the rearrangement. According to this rule, the first rearrangement mode, as shown in FIG. 9A, can be the case DCT0 of performing discrete cosine transform by a general method without rearrangement or the first rearrangement mode, as shown in FIG. 9B and FIG. 9C, and the cases DCT1 and DCT2 of using two kinds of methods of rearranging residuals existing on a left side of 4*4 residual signals in the top side.

FIGS. 10A to 10D are diagrams for coefficients obtained from performing discrete cosine transform after rearranging 4*4 residual signals by a first rearrangement mode. Using the same 4*4 residual signals having the coefficients shown in FIG. 10A, in case of performing discrete transform without rearrangement [DCT0], the discrete cosine transform coefficients is presents shown in FIG. 10B. However, if discrete cosine transform is performed after rearrangement in modes DCT1 and DCT2, discrete cosine transform coefficients, as shown in FIG. 10C and FIG. 10D, are obtained.

In case of adopting the scheme for performing the discrete cosine transform by rearranging the residual signals, an encoder encodes the discrete cosine transform coefficients and rearrangement information related to the three kinds of modes entirely. And, the encoder calculates a bit rate and an extent of distortion (RD cost) in performing discrete cosine transform by performing the three kinds of the modes. Hence, a decoder performs decoding in a manner of selecting a signal transformed into a mode of lowest cost among DCT0, DCT1 and DCT2 by comparing the bit rate and distortion extent (RD cost) calculated by the encoder.

Meanwhile, FIGS. 11A to 11I shows a discrete cosine transform method including a rearrangement step of 4*4 residual signals using a second rearrangement mode, in which the second rearrangement mode includes nine kinds of modes (mode 0 to mode 8) according to rearrangement schemes. Residual signals are obtained from prediction. And, the prediction has nine kinds of modes. Each of the prediction modes has different directionality and each pixel is obtained through the different prediction mode, whereby residual signals can obtain different directionality and similarity according to the corresponding prediction mode. Therefore, the second rearrangement mode constructs a discrete cosine transform method of a residual signal differing in prediction mode by considering the above-described prediction modes.

Referring to FIGS. 11A to 11C, modes 0, 1 and 2 constructing a second rearrangement mode indicate the cases (mode 0, mode 1, mode 2) that 4*4 residual signals are predicted using vertical, horizontal and average values (DC). In this case, the modes 0, 1 and 2 indicate the scheme for performing discrete cosine transform without rearrangement of the residual signals.

Referring to FIGS. 11D to 11I, FIG. 11D shows a case that a residual signal is predicted in a diagonal down-left direction corresponding to a predict mode 3, FIG. 11E shows a case that a residual signal is predicted in a diagonal down-right direction corresponding to a predict mode 4, FIG. 11F shows a case that a residual signal is predicted in a vertical-right direction corresponding to a predict mode 5, FIG. 11G shows a case that a residual signal is predicted in a diagonal down-right direction corresponding to a predict mode 6, FIG. 11H shows a case that a residual signal is predicted in a vertical-left direction corresponding to a predict mode 7, and FIG. 11I shows a case that a residual signal is predicted in a horizontal-up direction corresponding to a predict mode 8.

Thus, in case that discrete cosine transform is performed by rearranging residual signals according to a prediction mode prior to discrete cosine transform, discrete cosine transform coefficients are distributed by gathering around a left side (DC component). Therefore, it is able to obtain higher compression effect.

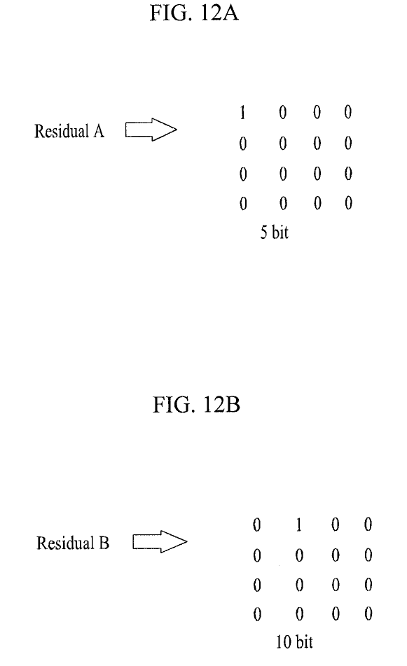

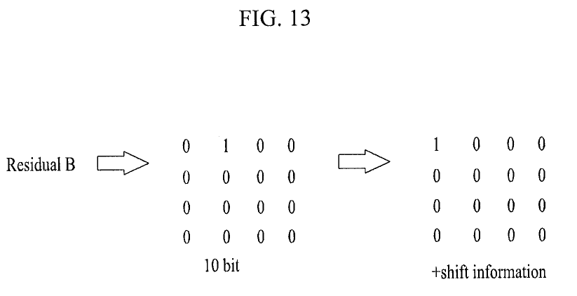

A fifth embodiment of the present invention proposes a discrete cosine transform (DCT) coefficient shift scheme to raise coding efficiency of a residual signal. The discrete cosine transform coefficient shift scheme is explained with reference to FIG. 12 and FIG. 13 in the following description.

FIG. 12A and FIG. 12B show discrete cosine transform coefficients obtained from transforming and quantizing 4*4 residual data A and B differing from each other. Coding efficiency considerably depends on distribution of discrete cosine transform coefficients. Referring to FIG. 12A, a discrete cosine transform coefficient for the residual data A has a value of 1 at (1,1) only. To represent this, about five bits are used for coding. On the contrary, referring to FIG. 12B, a discrete cosine transform coefficient for the residual data B has a value of 1 at (2,1) only. To represent this, about ten bits are used for coding, unlike the case of residual data A.

A discrete cosine transform coefficient matrix of the residual data B is identical to that of the residual data A in case of shifting a column of the discrete cosine transform coefficient matrix of the residual data B to the left once. Hence, a video signal processing method and apparatus using a discrete cosine transform shift scheme according to a fifth embodiment of the present invention is able to enhance coding efficiency by shifting a matrix to have a minimum bit rate and transporting discrete cosine transform coefficient shift information relevant to the matrix shift separately.

A discrete cosine transform shift scheme according to a fifth embodiment of the present invention is able to select a matrix having a smallest number of used bits in a manner of respectively encoding a non-shifted discrete cosine transform (DCT) coefficient matrix, a left-side-of-row shifted DCT coefficient matrix and an up-side-of-column shifted DCT coefficient matrix.

FIG. 13 is a diagram for a discrete cosine transform coefficient matrix of the residual B shown in FIG. 12B according to a fifth embodiment of the present invention. First of all, a discrete cosine transform coefficient matrix of the residual B becomes identical to that of the residual A if a row of the discrete cosine transform coefficient matrix of the residual B is shifted to the left. The shifted transform coefficient matrix can be coded using about five bits. Moreover, it is able to separately transport discrete cosine transform coefficient shift information indicating that the transform coefficient of the residual B has been shifted. Since the transportation of the shift information is enabled using about one or two bits, the discrete cosine transform coefficient matrix can be represented using the bit number (6˜7 bits) smaller than that (10 bits) of the case of not adopting the discrete cosine transform shift scheme. Therefore, coding efficiency can be improved.

The discrete cosine transform coefficient shift information (shift information) can further include information indicating a presence or non-presence of the shift, the shift direction and shift extent of the transform coefficient matrix in performing discrete cosine transform on the blocks.

Moreover, the encoding/decoding method of the present invention can be implemented in a program to be executed in a computer and can be recorded in a computer-readable recording medium. And, multimedia data having a data structure according to the present invention can be recorded in a computer-readable recording medium. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, a bit stream produced by the encoding method is stored in a computer-readable recording medium or can be transmitted via wireline/wireless communication network.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, the present invention is applicable to audio encoding and decoding.

What is claimed is:

1. A method of processing a video signal, comprising:
receiving the video signal;
extracting discrete cosine transform information from the video signal; and
performing inverse discrete cosine transform using the discrete cosine transform information,
wherein the discrete cosine transform information indicates a rearrangement mode of blocks in the discrete cosine transform.

2. The method of claim 1, wherein the discrete cosine transform information includes a first rearrangement mode not considering a prediction mode of the blocks and a second rearrangement mode considering the prediction mode of the blocks.

3. The method of claim, 2, wherein the second rearrangement mode includes nine kinds of modes according to an intra-prediction mode of the blocks.

4. The method of claim 2, wherein each of the first rearrangement mode and second rearrangement mode concentrates low frequency components of the blocks on a left top.

5. The method of claim 1, wherein the blocks comprise 8*8 blocks.

6. The method of claim 1, wherein the blocks comprise 4*4 blocks.

7. The method of claim 1, further comprising:
extracting reduced resolution update information from the video signal; and
performing the inverse discrete cosine transform using the reduced resolution update information.

8. The method of claim 7, wherein the reduced resolution update information indicates whether to perform the inverse discrete cosine transform by upsampling the blocks.

9. The method of claim, 8, wherein the upsampling is performed in a discrete cosine transform domain.

10. The method of claim 8, wherein the upsampling substitutes 0 for a high frequency component eliminated in encoding by being downsampled.

11. The method of claim 10, wherein the downsampling is performed by eliminating samples located at points over a predetermined point in a discrete cosine transform domain in encoding the video signal.

12. The method of claim 1, further comprising:
extracting discrete cosine transform coefficient shift information from the video signal; and
performing the inverse discrete cosine transform using the discrete cosine transform coefficient shift information.

13. The method of claim 12, wherein the discrete cosine transform coefficient information indicates a presence or non-presence of a shift, shift direction and shift extent of a transform coefficient matrix in performing discrete cosine transform of the blocks.

14. A method of processing a video signal, comprising:
receiving the video signal;
extracting reduced resolution update information from the video signal; and
performing inverse discrete cosine transform by upsampling blocks in a discrete cosine transform domain using the reduced resolution update information.

15. A method of processing a video signal, comprising:
transforming a block of the video signal including N samples in a discrete cosine transform domain; and
performing downsampling by selecting the sample existing on a point equal to smaller than N/2 in the discrete cosine transform domain.

16. The method of claim 1, wherein the video signal is received via a video signal.

17. The method of claim 1, wherein the video signal is received via a digital medium.

18. A computer-readable-medium comprising a program recorded therein to execute the method of claim 1.

19. A method of processing a video signal, comprising:
receiving a video signal including blocks;
rearranging the received blocks;
performing discrete cosine transform on the rearranged blocks; and
generating discrete cosine transform information indicating a presence or non-presence of the rearrangement and a rearrangement scheme.

20. An apparatus for processing a video signal, comprising:
a receiving unit receiving the video signal subdivided into block areas;
an extracting unit extracting discrete cosine transform information from the received video signal;
an inverting unit performing inverse discrete cosine transform using the discrete cosine transform information,
wherein the discrete cosine transform information indicates a rearrangement mode of blocks in the discrete cosine transform.

21. An apparatus for processing a video signal, comprising:
a receiving unit receiving the video signal;
a block rearranging unit dividing the received video signal into areas of blocks, each having a predetermined size, the block rearranging unit rearranging the blocks;
a transform unit performing discrete cosine transform on the rearranged blocks; and
an information generating unit generating discrete cosine transform information indicating a presence or non-presence of the rearrangement and a rearrangement scheme.
